(19) United States
(12) Patent Application Publication
(10) Pub. No.: US 2007/0051336 A1
(43) Pub. Date: Mar. 8, 2007

(54) Method for hardening and tempering cylinder heads, and cylinder heads for internal combustion engines

(76) Inventors: Andreas Barth, Leinfelden-Echterdingen (DE); Franz Rueckert, Ostfildern (DE)

Correspondence Address: AKERMAN SENTERFITT, P.O. BOX 3188, WEST PALM BEACH, FL, 33402-3188, US

(21) Appl. No.: 10/557,159

(22) PCT Filed: May 10, 2004
(86) PCT No.: PCT/EP04/04951

§ 371 Date: Aug. 4, 2006

(30) Foreign Application Priority Data
May 17, 2003 (DE) 10322309.6

(51) Int. Cl. F02F 1/42; B23P 11/00

(52) U.S. Cl. 123/193.5; 29/888.06

(57) ABSTRACT

The invention relates to a process for quenching and tempering of cast cylinder heads for internal combustion engines as well as such cylinder heads, in particular cylinder heads made from cast aluminum or an aluminum alloy, in which the cylinder head 1 is heat treated subsequently to the casting, in which the cylinder head 1 is adaptively adjusted heat treated in the different regions 2, 3 according to the thermal and mechanical requirements of said regions 2, 3.

### CROSS REFERENCE TO RELATED APPLICATION

This application is a national stage of PCT/EP2004/004951 filed May 10, 2004 and based upon DE 103 22 309.6 filed May 17, 2003 under the International Convention.

### BACKGROUND OF THE INVENTION

1. Field of the invention

The invention relates to a process for quenching and tempering of cast cylinder heads for internal combustion engines as well as a cylinder head for internal combustion engines.

2. Related Art of the invention

The invention in particular relates to cylinder heads which are cast from aluminum or an aluminum alloy and a process for their fabrication. The conventional processes for the fabrication of aluminum based cylinder heads through casting use a heat treatment after the casting thus improving strength and thermal characteristics as well as the toughness of the material.

With this heat treatment especially the hardening alloy constituents like copper, magnesium and silicon are dissolved through solution annealing above a temperature of e.g. 470° C. Through a subsequent quenching in a water bath this dissolved state of the alloy constituents is metastably frozen at room temperature. Subsequently precipitation hardening phases are generated from the dissolved alloy constituents through an age hardening heat treatment at a temperature above 160° C. The latter significantly determine the strength and toughness properties of the cast cylinder head. It has been shown, that for each hardening temperature during the age hardening an optimal time for the hardening is given. At this temperature the strength of the material is maximal, but the toughness of the material is reduced. This state of a “medium size precipitation” of alloy constituents is usually called the T6-state. The strength is relatively high, whereas the ductility is lower. Beyond this T6-state, i.e. further age hardening, the precipitates which increase the strength continue to grow larger with time, so that the strength values like tensile strength or the permanent limit of elongation of the material start to decline only the toughness of the material increases again. This state of a thermal over-ageing is called the T7-state.

The T7-state is optimal for combustion chambers of cylinder heads because of its high fracture toughness and good resistance against fatigue fissures, particularly in geometries which are relatively thin and vulnerable to notch effects like the geometries of the inter cylinder region like the chambers thereon, milling marks through the mechanical machining of the combustion chambers or the glow plug or heater plug bores etc. Moreover the high strength of the T6-state is useless since during operation of the internal combustion engine relatively high temperatures develop in the combustion chambers and above 200° C. the material automatically changes from the T6-state into the T7-state within a sort time (usually within 100 hours). This transition comes along with an increase in volume thus compressive self-equilibrating stress develops in the structure of the material which ultimately through local temperature increase of the inter cylinder region during operation of the internal combustion engine may result in an irreversible plastification. During the subsequent cool down of the cylinder head tensile self-equilibrating stress develops in the inter cylinder region which may lead to thermal fatigue fissures. For this reason a T7-heat treatment is superior compared to a T6-heat treatment. In the former the developing volume growth already happened during the age hardening. On the other hand a disadvantage of the T7-state is the fact that the material becomes relatively soft even outside the combustion chamber region so that the cylinder head gasket to the crankshaft housing may over time imprint a grove into the cylinder head. This results in leaky cylinder heads and damage to the motor. Additionally it is desirable that the combustion chamber regions of cylinder heads for modern internal combustion engines are hardened at a temperature which is in the range of the operating temperature, which is for today's Diesel-/Otto-engines above 240° C. This would necessitate very high hardening temperatures and a very short or, as the case may be, non-uniform hardening of the cylinder head in order to avoid over-ageing. The consequence would be a non-reproducible heat treatment with significant disadvantages in high volume production.

### SUMMARY OF THE INVENTION

It is the objective of the invention to provide a process for quenching and tempering of cast cylinder heads for internal combustion engines as well as analogous cylinder heads which ensures a better reproducibility in the fabrication at improved material properties in particular with respect to strength and fatigue resistance in a simple constructive manner.

According to the process for quenching and tempering of cast cylinder heads for internal combustion engines according to the invention, like e.g. Diesel- or Otto-engines, the cylinder head consisting of an aluminum alloy or a cast aluminum is heat treated after casting, in which it is adjusted differently and adaptively heat treated in different regions according to the different thermal and mechanical requirements with respect to the other regions of the cylinder head. Thus the combustion chamber regions of the cast cylinder head receive an optimized heat treatment while preventing the occurrence of insufficient strength in the rest of the cylinder head. As far the thermal and mechanical requirements of these combustion chamber regions go with respect to the rest of the cylinder head, they need a relatively high toughness of the material whereas the strength like the tensile strength and the permanent limit of elongation of the material do not need to be as high. The ductility of the combustion chamber regions can be relatively high with the process according to the invention, whereas the strength of the material exhibits medium values.

Nevertheless the whole rest of the cylinder head (non combustion chamber region), particularly the bottom plate and the outer side regions as well as the supporting area for the cylinder head gasket, can be fabricated with a different heat treatment or, as the case may be, different quenching and tempering on the top side, so that they are less ductile but feature the higher strength which is necessary in these regions. Thus the cylinder head gasket imprinting a grove into the cylinder head because of a low material strength is effectively prevented. The load limit and the resistivity against fissures or fatigue of the cylinder head are significantly reduced. The high strength and hardness values in the combustion chamber regions according to the invention are only produced directly in those regions, so that an adjustment or, as the case may be, an adaptive adjustment of thermal and mechanical strength- and material-properties per region is possible. The heat treatment for the hardening of the cast cylinder head is different depending on the according requirements in the different regions thus avoiding damage to the cylinder head caused by variations in the thermal expansion and/or structural changes. The strengths and/or the plastic ductility of the materials are optimized for different regions depending on the commensurate requirements.

In an advantageous embodiment of the invention the heat treatment consists of the steps: solution annealing, quenching and age hardening, in which the combustion chamber regions of the cylinder head during the age hardening are locally treated at higher temperature that the rest of the cylinder head. Thereby the combustion chamber regions can be brought into the state of thermal over-ageing which is optimal for these regions, in which the strength values are reduced but the toughness of the material of the cylinder head improves (T7-state). The higher temperature for the local regions of the combustion chambers and their close vicinity is achieved by a suitable means, like an additional heat source or such. Especially a higher temperature during the age hardening of the cast cylinder heads can be achieved through local additional heat sources such as gas burners of such. The conventional age hardening of the complete cylinder head which is done at relatively low temperatures usually between 160° C. and 220° C. happens in parallel and/or prior to the second step of the local age hardening of the combustion chambers according to the invention.

According to an advantageous embodiment of the process according to the invention the heat treatment is done in two steps, with a second step in which the combustion chamber regions of the cylinder head are treated at a higher temperature locally and directly subsequent to the first step. The temperature of the second step for the local heat treatment of the combustion chamber regions is higher than the temperature of the first step for the complete cylinder head. The local increase in temperature can be accomplished by every suitable means with which different temperatures can be realized in different regions of the cylinder head. Such combustion chamber regions can be made with special material or, as the case may be, structural properties without compromising the strength of the overall cylinder head.

According to another advantageous embodiment of the invention the additional or, as the case may be, different heat treatment of the combustion chamber regions of the cylinder head is accomplished by additional local heating in the combustion chamber regions during the age hardening. The additional heating can be accomplished according to one advantageous aspect through a laser, a burner or electronically through high frequent induction energy. Here the heating is done by a number of means according to the number of combustion chambers through which a local temperature increase is accomplished. As a matter of course the transitions to the combustion chamber regions and the rest of the cylinder head is continuous and a definition of a well defined borderline in a geometrical sense is impossible. It is essential for the invention that the combustion chamber regions, i.e. the inter cylinder regions, the cylinder bores and the inner regions of the material of the cylinder head directly adjacent to the combustion chambers are differently heat treated than the rest, especially the outside and the cylinder head plate. Through a heat treatment by a laser, a burner or a high frequent induction energy the regions of the combustion chamber can relatively easy be differently heat treated or, as the case may be, age hardened with respect to the rest of the cylinder head without the necessity to divide the cylinder head into various parts or different modules.

According to an advantageous embodiment of the invention the different heating in the combustion chamber regions is accomplished by cooling the other regions of the cylinder head with exception of the combustion chamber regions themselves. Trough cooling on the outside e.g. through cooling water or a cooling fluid which circulates around the outside and the bottom side of the cylinder head the different heat treatment of the combustion chamber regions with respect to the rest of the cylinder head can be accomplished with a constant heat source and constant heat inflow. Hence no additional provisions or, as the case may be, devices are necessary to accomplish the specific age hardening in the combustion chamber regions. With a conventional heat treatment apparatus, as it is known to the expert, the specific heat treatment according to the invention can be accomplished with one and the same one-piece cylinder head. Through heating by a laser, a gas burner or inductively relatively short heat up times to high temperatures are possible, so that relatively short and reproducible age hardening times can be achieved for the cylinder head.

According to an advantageous embodiment of the invention the heat application to the combustion chamber regions is pulsed and directly done at the end of a first, conventional age hardening of the cylinder head. The pulsed age hardening or, as the case may be, energy input prevents a constriction of the thermal expansion of the inter cylinder regions and fatigue fissures through an initial thermal damage. The local over-heating in the combustion chambers is prevented, so that no steep temperature gradients develop between to the surrounding colder regions.

The additional heat intake into the combustion chamber regions can alternatively also be done during the conventional age hardening of the cylinder head. Of essence for the invention is just that there is no large time delay between the conventional age hardening and the additional specific and localized hardening of the combustion chamber regions because otherwise the temperature difference between the hardened combustion chamber regions and the outer cylinder head regions will be too big. The latter may result in stress and subsequently fissures in the structure of the material.

According to an advantageous embodiment of the invention the cylinder head is in a first step exposed to an age hardening at temperatures between 160° C. and 220° C. to generate a T6- or T7-state and subsequent in a second step an age hardening to a higher state, in particular the T7-sate, is performed only locally in the combustion chamber regions. The second step of the age hardening is preferably done at a temperature which is at least equal to the operating temperature in the combustion chambers later on. Thus fatigue endurable and highly stable cylinder heads can be fabricated cost efficient through a simple, multi-step heat treatment. The different regions of the cylinder head can be adaptively optimized heat treated to the corresponding requirements without complicating or adding significant time to the fabrication process. The two-tiered age hardening ideally happens in parallel or alternatively directly after each other. Relatively lightweight but highly stable cylinder heads can be fabricated from aluminum alloys and the danger of fissuring or material induced weaknesses is reduced.

The cylinder head of an internal combustion engine made in particular from an aluminum alloy features a number of combustion chamber constituting cylinders as well as a bottom plate and a number of inter cylinder regions in which the combustion chambers and the inter cylinder regions together with their direct vicinity constitute combustion chamber regions. These combustion chamber regions are depending on the thermal and mechanical requirements adaptively adjusted and differently with respect to the rest of the cylinder head heat treated. Through the adaptively adjusted specific heat treatment of the cylinder head regions it is possible that in a one piece casting of the cylinder head the outer regions feature high strength values with respect to mechanical loads e.g. through the compressed cylinder head gasket thus preventing imprinting a grove into or damaging the cylinder head over long periods of operation. The combustion chamber regions of the cylinder head on the other hand can exhibit lower strength values, but a high ductility specifically in their material structure. For a cylinder head according to the invention the high operating temperatures particularly in modern Diesel engines which are in the order of over 240° C. do not cause material stress and/or fissures. The durability of the cylinder head is improved with respect to conventional cylinder heads made from cast aluminum.

According to an advantageous aspect of the invention the different thermal treatment in the combustion chamber regions of the cylinder head is such that a T7-heat-treatment-state is established in the combustion chamber regions. The T7-heat-treatment in the combustion chamber regions leads to a high fracture toughness and thereby to an optimized resistivity against thermal fatigue fissures. This is of advantage particularly in geometries which are relatively thin and vulnerable to notch effects like the geometries of the inter cylinder region like the chambers thereon, milling marks through the mechanical machining of the combustion chambers or the glow plug or heater plug bores etc. In addition compressive and tensile self-equilibrating stress in the material structure through the engines operation is thereby prevented. A locally different heating of the various regions of the cylinder head during engine operation is not detrimental for the overall cylinder head.

According to an advantageous aspect of the invention the combustion chamber regions are heat treated according to an operating temperature of the engine or, as the case may be, of the combustion chambers in particular at a temperature greater than 240° C. An initial thermal damage through different heat treatment in different regions of the cylinder head is avoided. The development of fatigue fissures and structural stress is largely prevented even during operation of the engine.

### BRIEF DESCRIPTION OF THE DRAWINGS

Additional advantages and characteristics of the invention are described in detail in the following, in which the invention is elucidated in more detail with respect to the embodiments according to the attached illustrations.

They show:

FIG. 1 a perspective view of a first embodiment of a process according to the invention for quenching and tempering cylinder heads with inductive heat generation;

FIG. 2 a perspective view of a second embodiment of a process according to the invention for quenching and tempering cylinder heads with heat generation by means of gas burners;

FIG. 3 a perspective view of a third embodiment of a process according to the invention for quenching and tempering cylinder heads with heat generation by means of laser;

FIG. 4 A perspective view of a first embodiment of a process according to the invention for quenching and tempering cylinder heads with external water cooling;

FIG. 5 A perspective view of a first embodiment of a process according to the invention for quenching and tempering cylinder heads with thermal insulation of the combustion chambers during quenching.

### DETAILED DESCRIPTION OF THE INVENTION

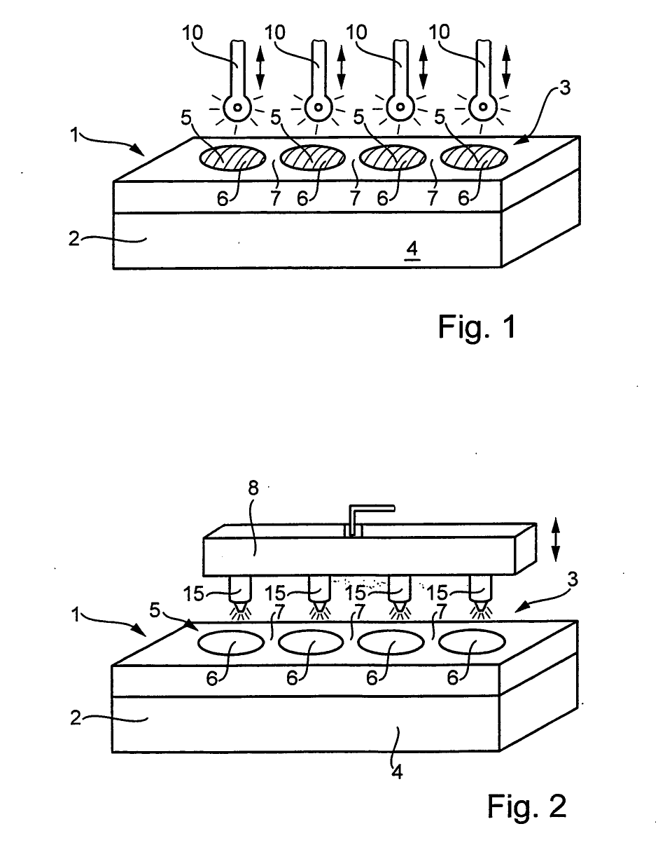

FIG. 1 shows in a perspective view a first embodiment for the quenching and hardening of a cylinder head through heat treatment according to the invention. The cylinder head 1 features combustion chamber regions 3 which are constituted by the combustion chambers themselves and the inter cylinder region 7 as well as the direct vicinity of the cylinders 5. The cylinder head 1 features also a bottom plate 4 and an outer region 2 in the following this is referred to as non combustion chamber region. As a matter of course the transitions between the combustion chamber region 3 and the non combustion chamber region 2 are not straight lined and clearly distinguishable regions of the cylinder head 1, in practice the transitions will be rather blended between the combustion-chamber-region 3 and the outer region 2.

The cast cylinder head 1 consists preferably of an aluminum alloy like AlSi7Mg, AlSi10Mg, AlSi6Cu4, AlSi9Cu3 etc. The cylinder head 1 is heat treated after casting and, according to the invention, differently adaptively adjusted heat treated in different regions. The combustion chamber region 3 of the cylinder head is, during the heat treatment, provided with additional heat energy by induction heaters 10 through a number of inductors 10 which is equal to the number of cylinders 6. For this the inductors 10 can be moved into the according combustion chambers 6 of the cylinders 5. The additional heat treatment of the combustion chamber regions 3 with the inductors 10 is preferably done directly subsequent to the conventional heat treatment or, as the case may be, age hardening of the cylinder head 1 or simultaneously. The conventional quenching and hardening of the complete cylinder head 1 is done with the process steps of a solution annealing, especially above 470° C. Through a subsequent quenching of the cylinder head 1 in a water bath this dissolved state of the alloy constituents is metastably frozen at room temperature. Then the cylinder head 1 is age hardened at a temperature preferably above 160° C., e.g. in a furnace (not shown here). Thus a state of the material is achieved which is called the T7-state in which the strength values according to an optimal hardening temperature over an optimal time are maximized, at an as low as possible material toughness.

This known process for quenching and tempering is, according to the invention, superposed or, as the case may be, amended through a region-wise specific heat treatment or, as the case may be, age hardening in the combustion chamber regions 3. The latter are additionally hardened beyond the so-called T6-state e.g. through the, as shown in FIG. 1, inductive heating through induction coils and high frequent alternating current which causes eddy currents. This way the combustion chamber regions 3 are transformed into the T7-state in which the aluminum material or, as the case may be, the aluminum alloy are thermally over-aged and the toughness is increased whereas the strength values are decreased with respect to the T6-state. Thereby different thermal treatments adjusted according to the thermal and mechanical requirements in the combustion chamber regions 3 and the outer regions 2 of the cylinder head are realized. The outer strength of the cylinder head 1 is necessary in particular with aluminum based cylinder heads so that during the operation of the engine the cylinder head gasket does not imprint a grove into the material over time resulting in leaks at the engine between the crank shaft housing and the cylinder head 1.

FIG. 2 shows a perspective view of a second embodiment of the process for quenching and tempering of a cylinder head according to the invention. In contrast to the previous embodiment in FIG. 1 the heat transfer into the combustion chamber region 3 for the different heat treatment of different regions of the cylinder head 1 is here accomplished by means of a gas burner 8 which features a number of burner nozzles 15 according to the number of cylinders 5 and which can be moved into the combustion chambers 6. The age hardening is done in the combustion chamber regions 3 by burner flames of preferably a gas burner 8 which point into the direction of the combustion chambers 6 of the cylinder head 1. Through the additional heat input by means of the gas burner 8 into the combustion chamber areas 3, i.e. the direct vicinity of the cylinder 5 and the inter cylinder region 7, the material of the one-piece cast cylinder head 1 is specifically and adjusted heat treated and transformed into preferably a T7-state. The cylinder head 1 is treated outside of the combustion chamber areas 3, i.e. in the outer regions 2 and especially on the outside and on the seal surface of the cylinder head gasket (not shown), by a conventional heat treatment. The latter is preferably a heat treatment or, as the case may be, an age hardening over a period of time and at a temperature which leads to a T6-state (corresponding to a medium size precipitation of precipitation hardening phases of the alloy elements).

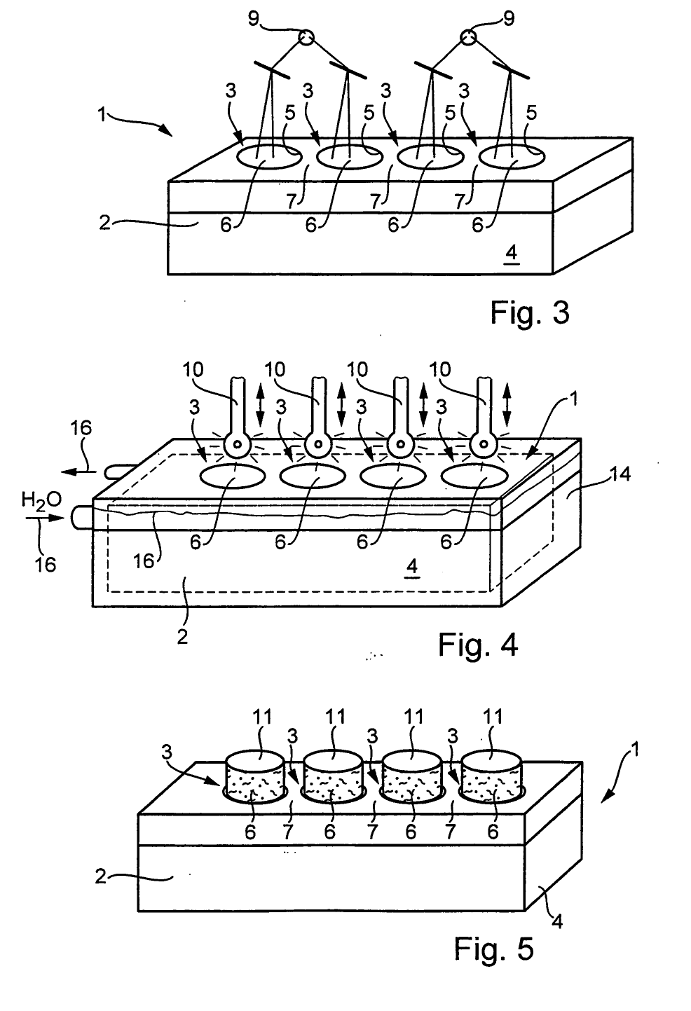

Another alternative embodiment of the process for quenching and tempering of a cylinder head from cast aluminum according to the invention is shown in a perspective view in FIG. 3. Instead of using a gas burner or inductive heat generation as discussed in the previous exemplary embodiments here a laser 9 is utilized to perform the additional age hardening in the combustion chamber regions 3 of the cylinder head 1. The laser 9 features a number of laser beams corresponding to the number of cylinders 5, four in the example on hand. By means of the lasers a localized heat input into the combustion chambers 6 of the cylinders 5 is possible. The heat input serves an additional age hardening of said combustion chamber regions 3 with respect to the rest 2 and especially of the outside of the cylinder head 1. The bottom plate 4 and the outer regions 2 of the cylinder head 1 which are located around the combustion chamber regions 3 are only treated by a conventional age hardening, i.e. preferably a T7 age hardening with the according times and temperatures depending on the material.

The variability of the properties within the cast cylinder head 1 can advantageously be adaptively adjusted to the load requirements and operational demands on hand. As in the previous embodiments FIG. 2 and 1 the specific multi stage treatment according to the invention allows generating a stable ductile state in the combustion chamber regions 3 and at the same time maintaining a high strength material state and improved wear resistance in the outer areas. Thus fatigue resistant and highly stable cylinder heads 1 can be fabricated economically through a simple, multi-step heat treatment. The process for quenching and tempering of cylinder heads from cast aluminum or, as the case may be, aluminum alloys according to the invention excludes potential weak spots in the production, e.g. different materials, welding seams, coatings or such. The quenching and tempering is sufficiently reproducible for volume production.

In FIG. 4 an alternative embodiment of the process according to the invention is shown in perspective view. Here the cylinder head 1 is cooled on the outside by means of cooling water 16 in a cooling vat 14 during heat input of the inductors 10 into the combustion chamber region 3. The additional cooling particularly of the bottom plate 4 and the outer regions 2 of the cylinder head 1 allows an additional heat input by means of the inductors 10 without changing the age hardening state in the outer region 2 of the cylinder head 1. The cooling water 16 at the input is preferably at a temperature above 20° C.

Alternatively, FIG. 5 shows an embodiment in which, instead of an outer cooling by means of cooling water, the combustion chamber areas 3 are held at a higher temperature level for a longer time than the rest of the cylinder head 1 by means of an insulating material 11. This is achieved by inserting the insulating material 11 into the cylinders 5 or, as the case may be, the combustion chambers 6 during the quenching step, thus reducing the speed of temperature reduction in those regions. The age hardening is performed, for instance, over two to six hours at a temperature between 160° C. and 220° C. with a subsequent quenching with the insulation material 11 in the combustion chamber regions 3.

All previously described embodiments of the process according to the invention with adaptive properties in different regions of the cylinder head 1 include the process steps: solution annealing at temperatures especially above 470° C., a subsequent quenching of the entire cylinder head 1 and a local hardening or quenching in the combustion chamber areas 3, which is different and specific compared to the rest of the cylinder head 1. Additionally the entire cylinder head 1 is age hardened by means of the conventional processes. The steps of a specific and localized hardening with additional heat input and/or cooling or thermal insulation may be done prior to the hardening of the entire cylinder head or subsequently to it.

All of the characteristics and elements described in the following claims as well as in the illustrations can be essential for the invention individually or in any combination thereof.

1-15. (canceled)

16. A cylinder head (1) of an internal combustion engine made of a heat treated aluminum alloy, including a number of cylinders (5) constituting combustion chambers (6), with a bottom plate (4) and a number of cylinder regions (7) in which the combustion chambers (6) and the cylinder regions (7) together with their direct vicinity constitute combustion chamber regions (3), wherein the cylinder head exhibits a locally limited condition of thermal hardening, and wherein the cylinder regions (7) exhibit a locally limited T7 state of age hardening.

17. A cylinder head (1) according to claim 16, wherein the combustion chamber areas (3) are heat treated to achieve a T7 state.

18. A cylinder head (1) according to claim 16, wherein with respect to the non-combustion chamber regions (2), the combustion chamber areas (3) are additionally heat treated at a temperature at least equal to the operating temperature of the combustion chambers (6) of the internal combustion engine

19. A cylinder head (1) according to claim 18, wherein said additional heat treatment is at a temperature above 240° C.

20. A process for quenching and tempering of cast cylinder heads (1) for internal combustion engines, the cylinder heads (1) being made from cast aluminum or cast aluminum alloy, the cylinder head (1) being heat treated after casting, the cylinder heads (1) including a number of cylinders (5) constituting combustion chambers (6), with a bottom plate (4) and a number of cylinder regions (7), in which the combustion chambers (6) and the cylinder regions (7) together with their direct vicinity constitute combustion chamber regions (3),
wherein the age hardening of the cylinder head (1) includes the following steps: solution annealing, quenching and age hardening, wherein they cylinder head during the age hardening is locally subjected to higher temperatures and/or treated for a longer time, and
wherein the cylinder regions (7) are locally limitedly treated until achieving a T7-state of age hardening.

21. A process according to claim 20, wherein the heat treatment is performed in two stages with a second stage in which the combustion chamber areas (3) are heat treated locally and directly subsequent to the first stage.

22. A process according to claim 20, wherein the differential heat treatment is accomplished by varying the local heat input into the combustion chamber regions (3) during age hardening.

23. A process according to claim 22, wherein the differential heat treatment is accomplished by thermal insulation (11) of the combustion chamber regions (3) during quenching.

24. A process according to claim 22, wherein the differential heat treatment is accomplished by cooling of the non-combustion chamber regions (2) of the cylinder head (1).

25. A process according to claim 20, wherein at least one bottom plate (4) of the cylinder head (1) is water cooled on the outside during the age hardening.

26. A process according to claim 23, wherein locally within the combustion chamber regions (3) additional age hardening takes place with respect to the rest of the cylinder head (1) through heat input by means of a burner (8), a laser (9) or high frequent induction energy (10), or an electron beam or a plasma emission.

27. A process according to claim 22, wherein the additional heat input is pulsed and performed directly at the end of a first, conventional age hardening.

28. A process according to claim 22, wherein the additional heat input is performed during a conventional age hardening of the cylinder head (1).

29. A process according to claim 20, wherein in a first step the entire cylinder head (1) is exposed to an age hardening at temperatures between 160° C. and 220° C. to generate a T6- or T7-state and subsequently in a second step an age hardening to a higher state, is performed only locally in the combustion chamber regions (3).

30. A process according to claim 29, wherein said higher state is the T7-sate.

31. A process according to claim 20, wherein in a first step an age hardening at temperatures between 160° C. and 220° C. is carried out only locally in the combustion chamber regions (3) to generate a T6- or T7-state, after which in a second step an age hardening of the entire cylinder head (1) is performed at temperatures between 160° C. and 220° C. to achieve a T6- or T7-state.

32. A process according to claim 30, wherein the temperature of the first step for the local heat treatment of the combustion chamber regions is higher than the temperature of the first step for the complete cylinder head.

33. A process according to claim 20, wherein the second step of an age hardening of the combustion chamber regions (3) is performed at a hardening temperature equal to or greater than the operating temperature of the combustion chambers (6) of the internal combustion engine.
